(19) United States
(12) Patent Application Publication
(10) Pub. No.: US 2025/0187881 A1
(43) Pub. Date: Jun. 12, 2025

(54) Electric Winch for Axial Electric Clutch and Control Method Thereof

(71) Applicant: Ningbo Chima Winch Co., Ltd, Zhejiang (CN)

(72) Inventor: Mingkui ZHENG, Zhejiang (CN)

(73) Assignee: Ningbo Chima Winch Co., Ltd, Zhejiang (CN)

(21) Appl. No.: 18/829,417

(22) Filed: Sep. 10, 2024

(30) Foreign Application Priority Data
Dec. 8, 2023 (CN) 2023116876749

(51) Int. Cl. B66D 1/12; B66D 1/22

(52) U.S. Cl. CPC B66D 1/12; B66D 1/22; B66D 2700/0141

(57) ABSTRACT

An electric winch for axial electric clutch comprises a first motor, a bracket, a winch drum and a planetary gear reducer; wherein, the first motor and the planetary gear reducer are respectively installed at two opposite ends of the bracket, and the winch drum is rotatably arranged between the first motor and the planetary gear reducer; the planetary gear reducer comprises an input-side planetary gear set and an output-side planetary gear set for driving the winch drum to rotate, and a transmission shaft passing through the winch drum is arranged between the first motor and the planetary gear reducer.

### CROSS-REFERENCE TO RELATED APPLICATIONS

This application claims the priority of China Patent Application No. 202311687674.9 filed on Dec. 8, 2023, entitled “Electric Winch for Axial Electric Clutch”, all the contents and amendments of which are incorporated into this application by reference.

### TECHNICAL FIELD

The present disclosure relates to the technical field of winches, in particular to an electric winch for axial electric clutch and a control method thereof.

### BACKGROUND

At present, a kind of electric winch is generally used in vehicles, such as off-road vehicles, ATVs, ships, etc. Of course, it can be used in other places where needed, that is, it has a wide range of application scenarios and is suitable for many occasions that need traction function.

When the electric winch is used, a traction rope needs to be released first. There are two ways to release the traction rope. One is that the motor rotates reversely to drive the winch drum to rotate reversely, which is slower. There is also a more efficient way, which is also the mainstream technical solution at present, that is, the motor is disconnected from the winch drum by unlocking the clutch device, so that the winch drum can be rotated more easily when the user pulls the traction rope. After releasing the traction rope, the user connects a traction hook to the towed object, and then engages the clutch device again to restore the transmission connection between the motor and the winch drum, so that when the motor is started, a torque can be output to pull the winch drum. With the development trend of electrification, an electric winch for axial electric clutch is also proposed in the prior art. The main idea is to completely cancel the original radial clutch structure and clutch operating handle, but to set the electric clutch structure in the axial direction instead.

For example, a winch with an electric clutch device is disclosed in CN patent No. CN104925688B. The solution disclosed in this patent realizes the purpose of electric axial clutch, but it does not further solve the problem of how to release the traction rope easily. According to the solution disclosed in the above patent, when the traction rope is released, the whole planetary gear reducer will still be driven by the winch drum to rotate, which will lead to greater resistance. In addition, when re-engagement is required, since the second transmission connecting section and the second transmission hole are not aligned, the second transmission connecting section and the second transmission hole have to be aligned for insertion, and at this time, the motor has been powered off and does not rotate, the planetary gear reducer can only be driven to rotate by the rotation of the winch drum, and the planetary gear reducer rotates to drive the primary central tooth to rotate. Because of the faster rotation speed of the primary center tooth, it is very difficult to align, which reduces the operational stability of the electric axial clutch, that is, re-engagement is difficult. Furthermore, due to the need for axial alignment, it is required that the axial machining accuracy of the transmission shaft and the axial matching accuracy with the primary central tooth should be very high, otherwise the problem of inaccurate axial movement may easily occur. Moreover, the transmission shaft is long, which is not conducive to production and manufacturing.

Therefore, there is a need to put forward a new type of electric winch, which is more conducive to releasing the traction rope more easily and is relatively easy to re-engage, and the requirements for the transmission shaft is reduced.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

The present disclosure provides an electric winch for axial electric clutch and a control method thereof to solve the problems that the traction rope is troublesome to be released and the clutch mechanism is difficult to re-engage.

In order to achieve the above object, the present disclosure provides an electric winch for axial electric clutch, which includes a first motor, a bracket, a winch drum and a planetary gear reducer; the first motor and the planetary gear reducer are respectively installed at two opposite ends of the bracket, and the winch drum is rotatably arranged between the first motor and the planetary gear reducer; the planetary gear reducer includes an input-side planetary gear set and an output-side planetary gear set for driving the winch drum to rotate, and a transmission shaft passing through the winch drum is arranged between the first motor and the planetary gear reducer; the winch drum has an input end, the output-side planetary gear set has an output end, and a connecting shaft is arranged between the input end of the winch drum and the output end of the planetary gear set; one end of the connecting shaft is muff-coupled with the input end and is axially slidable, and the other end of the connecting shaft is muff-coupled the output end and is axially slidable; a clutch transmission connection is realized between the input end and the output end through the axially slidable connection of the connecting shaft; the connecting shaft is muff-coupled with the transmission shaft, the transmission shaft and the connecting shaft can rotate relatively, and the connecting shaft is driven to slide axially by the transmission shaft for clutch; the transmission shaft is connected with an electric device, and the electric device is used for driving the transmission shaft to move axially when clutch is needed.

The present disclosure further provides an electric winch for axial electric clutch, which includes a bracket, a first motor and a planetary gear reducer respectively installed at opposite ends of the bracket, and a winch drum rotatably installed between the first motor and the planetary gear reducer; the planetary gear reducer includes an output-side planetary gear set for driving the winch drum to rotate, and a transmission shaft passing through the winch drum is arranged between the first motor and the planetary gear reducer; an electric clutch structure is arranged between the output-side planetary gear set and the winch drum, and the electric clutch structure includes an electric device and a connecting shaft; the connecting shaft is positioned between the winch drum and the output-side planetary gear set; one end of the connecting shaft is muff-coupled with the winch drum and is axially slidable, and the other end of the connecting shaft is muff-coupled the output-side planetary gear set and is axially slidable; the connecting shaft is muff-coupled with the transmission shaft, the transmission shaft and the connecting shaft can rotate relatively, and the connecting shaft is driven to slide axially by the transmission shaft during clutch; and the electric clutch structure is correspondingly provided with a controller.

The present disclosure also provides a method for controlling an axial electric clutch winch, including adopting an electric winch for axial electric clutch, which includes a first motor, a bracket, a winch planetary gear reducer and an electric clutch structure, wherein the electric clutch structure includes an electric device and a connecting shaft, the electric clutch structure is correspondingly provided with a controller, the controller includes a clutch button, and the electric device includes a second electromagnetic valve, a second telescopic shaft and a return spring; the electric device further includes a control unit which is in signal connection with the controller, and a driving unit and a conducting unit which are electrically connected with the control unit; the method includes the following steps:
Step 1, when a user operates the clutch button of the controller, the clutch button making the control unit output continuous conducting signals to the driving unit; and
Step 2, the conducting unit continuously conducting and outputting a high current according to the conducting signals to electrically operate the second electromagnetic valve, thereby pushing the second telescopic shaft to extend out to make the electric clutch structure in a separated state; and
Step 3, after the conducting signals last for a period of A, the control unit automatically changing the conducting signals into PWM signals to control the conducting unit, thereby reducing the current of the second electromagnetic valve from a high current to a low current, wherein the low current is used for maintaining a push-out state of the second telescopic shaft; and
Step 4, if the user does not operate the controller within a period of B, the control unit powering off the second electromagnetic valve, so that the second telescopic shaft automatically retracts by the return spring, and thereby the electric clutch structure is in an engaged state.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 is a front view of an electric winch for axial electric clutch.

FIG. 2 is an A-A sectional view of an electric winch for axial electric clutch in a separated state.

FIG. 3 is an A-A sectional view of an electric winch for axial electric clutch in an engaged state.

FIG. 4 is an A-A sectional view of another electric winch for axial electric clutch in a separated state.

FIG. 5 is an A-A sectional view of another electric winch for axial electric clutch in an engaged state.

FIG. 6 is a perspective view of another electric winch for axial electric clutch.

FIG. 7 is a schematic perspective view of a winch drum.

FIG. 8 is a perspective view of an axial electric clutch structure in an engaged state.

FIG. 9 is a perspective view of an axial electric clutch structure in a separated state.

FIG. 10 is a perspective view of FIG. 8 with the connecting shaft and transmission ring further removed.

FIG. 11 is a perspective view of a connecting shaft.

FIG. 12 is a perspective view of an end plate.

FIG. 13 is a schematic diagram of a lever-type electric device.

FIG. 14 is a perspective view of another electric winch for axial electric clutch.

FIG. 15 is a perspective view of the electric winch shown in FIG. 14 with the casing removed.

FIG. 16 is an axial semi-sectional view of the electric winch shown in FIG. 14 in a separated state.

FIG. 17 is an axial half-section schematic view of the electric winch shown in FIG. 14 in an engaged state.

FIG. 18 is a perspective view of a controller.

FIG. 19 is a schematic diagram of another embodiment of an electric winch for axial electric clutch.

FIG. 20 is a sectional view of FIG. 19.

FIG. 21 is the control principle diagram of the electric winch.

Reference signs: First motor (1); Bracket (2); Winch drum (3); Planetary gear reducer (4); Positioning groove (5); Transmission shaft (6); Input-side planetary gear set (7); Input sun gear (8); Output-side planetary gear set (9); Input end (10); Output end (11); Connecting shaft (12); Electric device (13); Spline hole (14); Spline section (15); Regular polygonal hole (16); Regular polygon section (17); Transmission ring (18); End plate (19); Retaining ring (20); Braking device (21); Spring (22); Second motor (23); Reducer (24); Rotating part (25); Mating part (26); First electromagnetic valve (27); Lever (28); First telescopic shaft (29); Second electromagnetic valve (30); Second telescopic shaft (31); Stop ring (32); First position sensor (33); Second position sensor (34); Trigger part (35); Transition shaft (36); Mounting seat (37); Axial blind hole (38); Track (39); Support (40); Casing (41); Electric push rod (42); Third telescopic shaft (43); Controller (44); Return spring (45); Component mounting area (46).

### DESCRIPTION OF EMBODIMENTS

In describing the preferred embodiments, specific termi-nology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

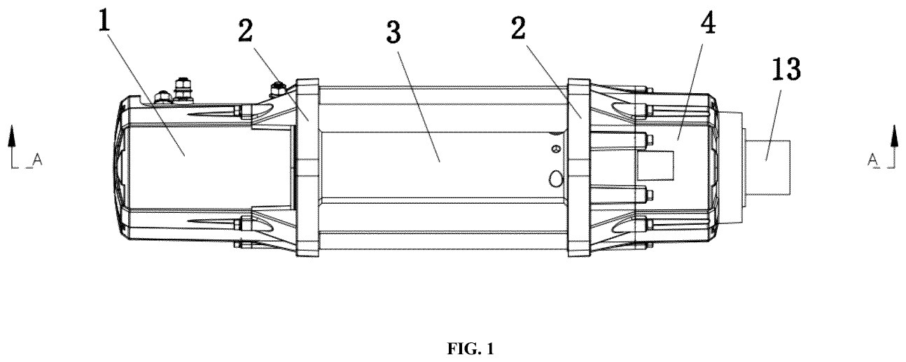

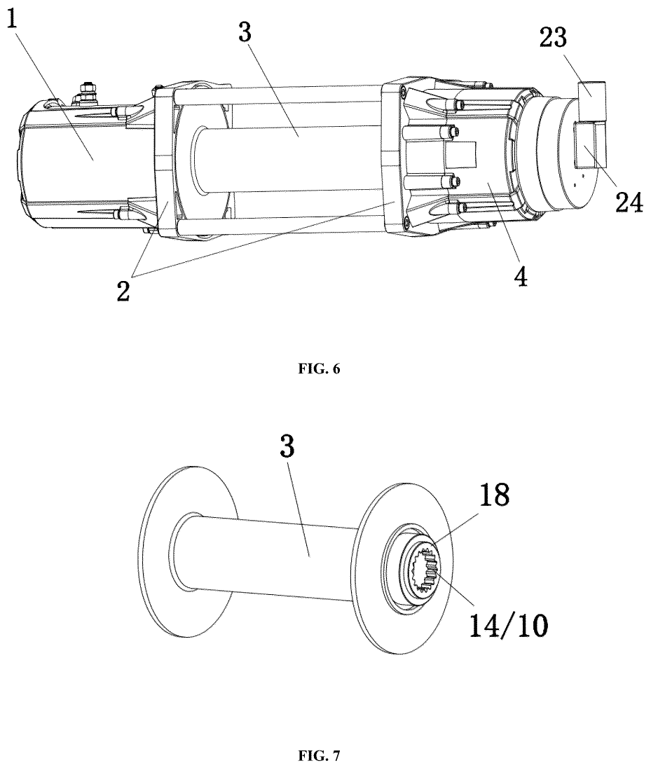

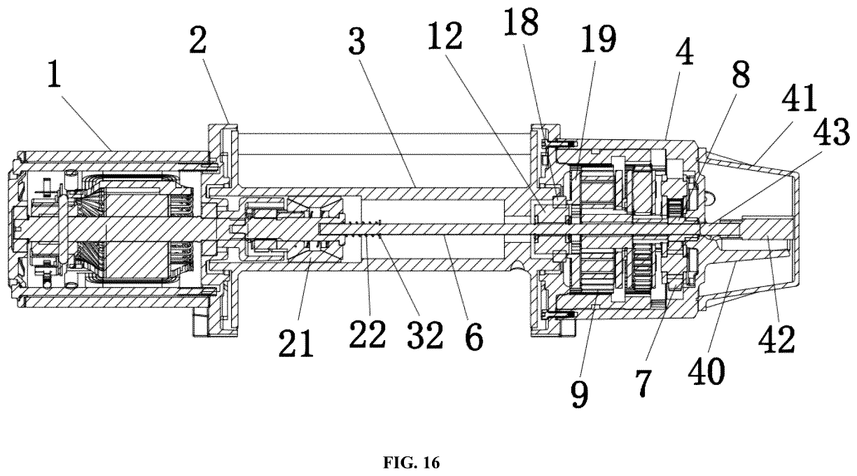

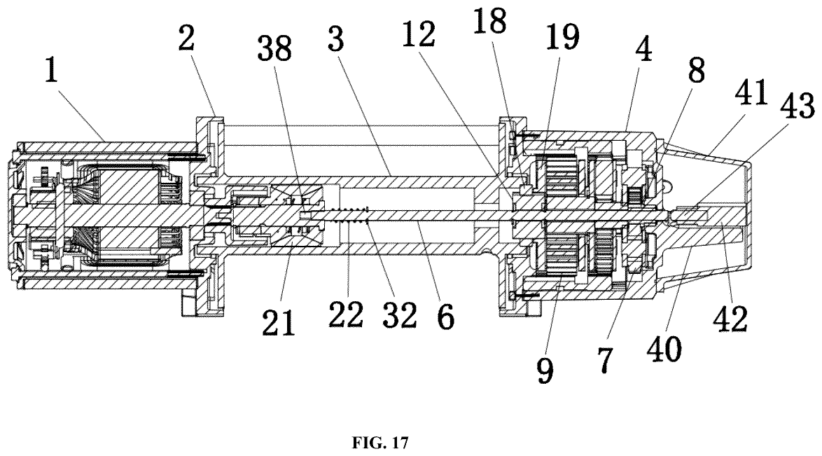

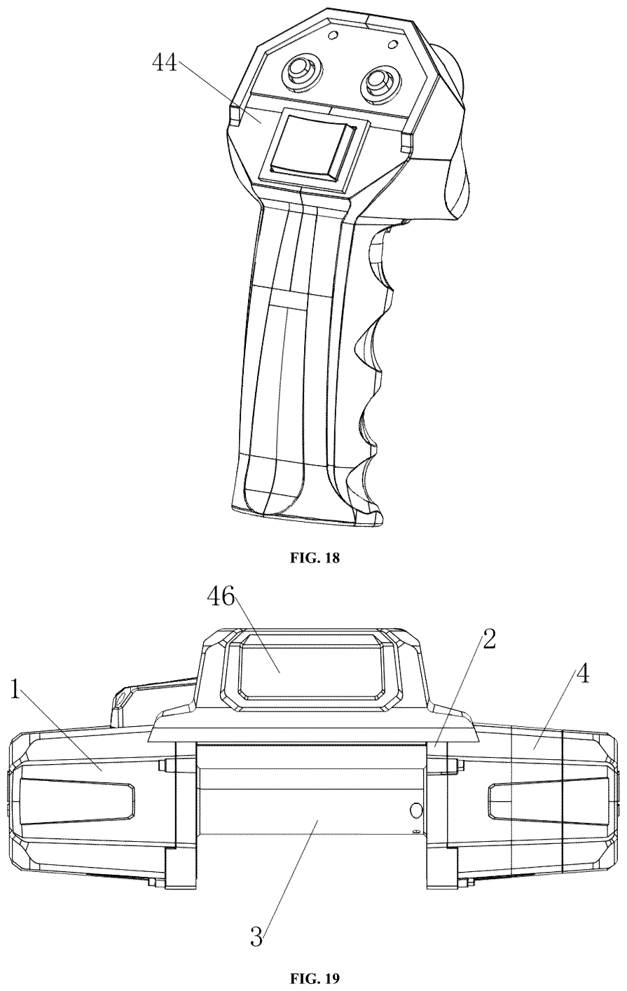

Please refer to FIG. 1 to FIG. 18;

The present disclosure provides an electric winch for axial electric clutch, which includes a first motor 1, a bracket 2, a winch drum 3 and a planetary gear reducer 4. The first motor 1 and the planetary gear reducer 4 are respectively installed at two sides of the bracket 2, the winch drum 3 is rotatably connected between the brackets 2, and the first motor 1 and the planetary gear reducer 4 are connected through a transmission shaft 6. The transmission shaft 6 passes through the winch drum 3 and reaches an input-side planetary gear set 7 of the planetary gear reducer 4, and is in transmission connection with the input sun gear 8 of the input-side planetary gear set 7. The input-side planetary gear set 7 is located at the side far away from the bracket 2, and the planetary gear set near the bracket 2 of the planetary gear reducer 4 is an output-side planetary gear set 9 for driving the winch drum 3 to rotate. A connecting shaft 12 is arranged between the input end 10 of the winch drum 3 and the output end 11 of the output-side planetary gear set 9. One end of the connecting shaft 12 is axially slidably muff-coupled with the input end 10, and the other end of the connecting shaft 12 can be axially and slidably muff-coupled with the output end 11. A clutch transmission connection is realized between the input end 10 and the output end 11 through the axially slidable muff-coupling of the connecting shaft 12. The connecting shaft 12 is also muff-coupled on the transmission shaft 6, and the transmission shaft 6 and the connecting shaft 12 can rotate relatively. When clutch is needed, the connecting shaft 12 is driven by the transmission shaft 6 to slide axially. The transmission shaft 6 is connected with an electric device 13, which is used to drive the transmission shaft 6 to move axially when clutch is needed.

In this embodiment, there are two ways of separation, namely, in a separated state, the connecting shaft 12 moves axially to achieve the purpose of separation from the output end 11, but the connecting shaft 12 keeps mull-coupled with the input end 10, and the input end 10 plays a role in radially supporting and axially guiding the connecting shaft 12. Alternatively, in a separated state, the connecting shaft 12 moves axially to achieve the purpose of being separated from the input end 10, but the connecting shaft 12 keeps mull-coupled with the output end 11, and the output end 11 plays a role in radially supporting and axially guiding the connecting shaft 12.

In some embodiments, in a case that the input end 10 plays the role of radial support and axial guidance for the connecting shaft 12, the input end 10 is provided with a spline hole 14, one end of the connecting shaft 12 is provided with a spline section 15, and the spline section 15 can be axially slidably muff-coupled with the spline hole 14. The output end 11 is provided with a regular polygon hole 16, the other end of the connecting shaft 12 is provided with a regular polygon section 17, and the regular polygon section 17 can be axially slidably muff-coupled with the regular polygon hole 16. When the output end 11 plays the role of radial support and axial guidance for the connecting shaft 12, the output end 11 is provided with a spline hole 14, the other end of the connecting shaft 12 is provided with a spline section 15, and the spline section 15 can be axially slidably muff-coupled with the spline hole 14. The input end 10 is provided with a regular polygon hole 16, one end of the connecting shaft 12 is provided with a regular polygon section 17, and the regular polygon section 17 can be axially slidably muff-coupled with the regular polygon hole 16.

In this way, although dividing the connecting shaft 12 into the spline section 15 and the regular polygon section 17 increases the cost, on the one hand, the matching between the spline section 15 and the spline hole 14 has better radial support performance and guiding stability, which is beneficial to the good clutch performance after multiple clutches in long-term use, and it is not easy to cause stability and reliability reduction due to excessive wear. On the other hand, the regular polygon section 17 and the regular polygon hole 16 are easier to align for insertion, which is more conducive to relatively easy re-engagement.

As shown in FIGS. 7, 11, and 12, it is preferable that the input end 10 plays a role of radially supporting and axially guiding the connecting shaft 12. This has the advantage that the axial dimension of the planetary gear reducer 4 can be reduced. Specifically, the end plate 19 of the planet carrier of the output-side planetary gear set 9 is provided with a muff-coupling hole, which is used as the output end 11. According to the above design, the thickness of the end plate 19 at the muff-coupling hole is not required to be thicker, which is beneficial to controlling the axial dimension of the end plate 19 and further reducing the axial dimension of the planetary gear reducer 4.

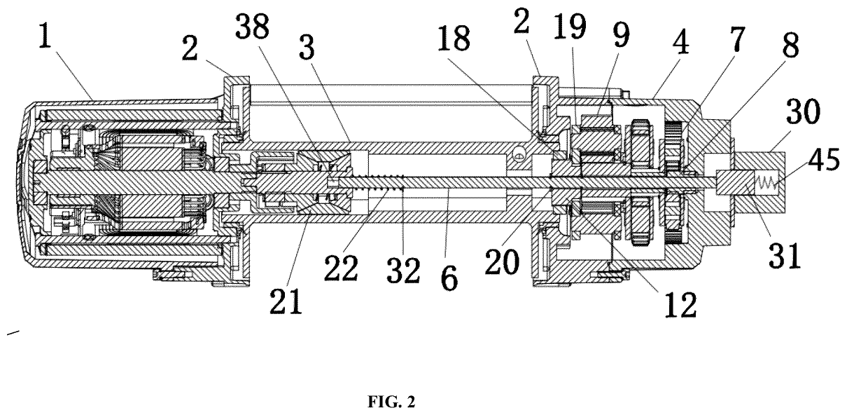

In some embodiments, as shown in FIGS. 2-5 and 7, the input end 10 is welded with a transmission ring 18, which serves as the input end 10 and is axially slidably muff-coupled with one end of the connecting shaft 12. According to this design, it is beneficial to simplify the production, improve the production efficiency and reduce the production cost, that is, when the winch drum 3 is manufactured, it can be manufactured according to the existing technology, and then a transmission ring 18 is welded on the winch drum 3 to realize the disclosed solution. Especially when the design of the spline hole 14 is used, it is obviously much more convenient to process the spline hole 14 for the transmission ring 18 than for the winch drum 3.

As shown in FIG. 2 to FIG. 5, the end of the winch drum 3 at the side of the output-side planetary gear set 9 is muff-coupled and welded with the transmission ring 18, so that the connection strength is better, and the axial size of the transmission ring 18 is reduced because the strength is enough.

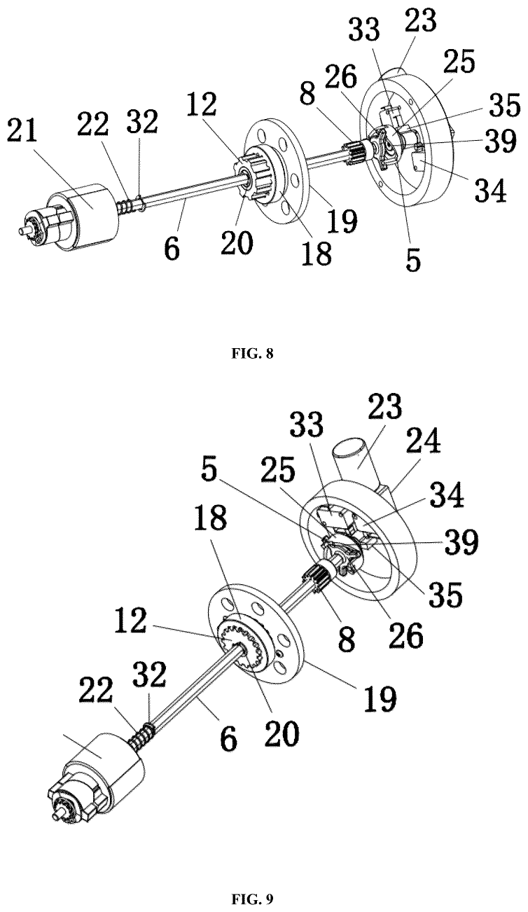

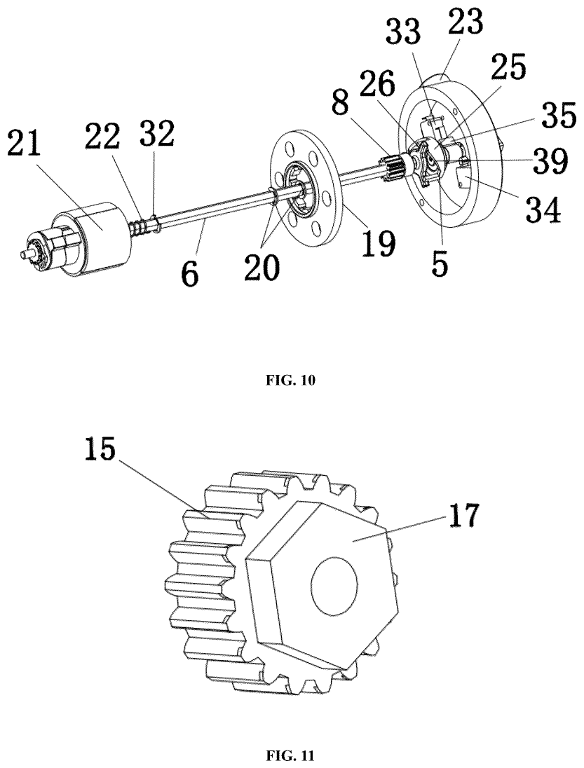

For the convenience of production and manufacturing, as shown in FIGS. 8 and 10, retaining rings 20 are respectively arranged on both sides of the connecting shaft 12, and the retaining rings 20 are connected with the transmission shaft 6. When the electric device 13 drives the transmission shaft 6 to move axially, the transmission shaft 6 pushes the connecting shaft 12 to move axially through the retaining rings 20.

Although the transmission shaft 6 shown in the attached FIG. is a regular hexagonal shaft, the hole in which the connecting shaft 12 and the transmission shaft 6 are muff-coupled and matched is set as a cylindrical hole, they can rotate relative to each other. There is a gap between the transmission shaft 6 and the connecting shaft 12, and thy will not affect each other when rotating.

In some embodiments, as shown in FIGS. 2 to 5 and 8 to 10, a braking device 21 is arranged between the first motor 1 and the transmission shaft 6. One end of the braking device 21 is connected with the first motor 1, and the other end of the braking device 21 is axially slidably muff-coupled with the transmission shaft 6. A spring 22 is arranged between the braking device 21 and the transmission shaft 6. When the engagement is needed, the electric device 13 is released, and the spring 22 can push the transmission shaft 6 to the side of the planetary gear reducer 4 to realize the purpose of driving and engaging the input end 10 and the output end 11 again by the connecting shaft 12.

As shown in FIG. 2 to FIG. 5 and FIG. 8 to FIG. 10, the transmission shaft 6 is provided with a stop ring 32 to limit the spring 22 between the braking device 21 and the stop ring 32, and the use of the stop ring 32 is beneficial to convenient production and manufacturing.

As can be seen from the attached drawings, the other end of the braking device 21 is provided with an axial blind hole 38, and the transmission shaft 6 can be inserted into the axial blind hole 38 in a sliding way. The axial blind hole 38 can play a role of radial support and axial guidance for the transmission shaft 6, and the axial blind hole 38 is arranged as an inner hexagonal blind hole corresponding to the regular hexagonal shaft. The main structure of the braking device 21 can adopt the prior art, and will not be described in detail here.

The release of the electric device 13 means that the electric device 13 releases the axial limit of the transmission shaft 6, so that the spring 22 can play a role.

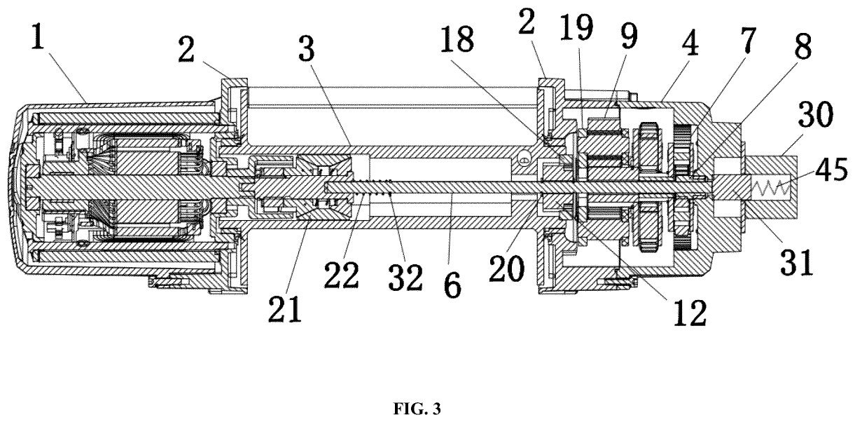

FIG. 2 is a cross-sectional view of an electric winch for axial electric clutch in a separated state, and FIG. 3 is a cross-sectional view of an electric winch for axial electric clutch in an engaged state. The electric device 13 of the electric winch for axial electric clutch includes a second electric telescopic unit, which adopts an electric push rod, a second electromagnetic valve 30, etc. Taking the second electromagnetic valve 30 as an example, the second electromagnetic valve 30 is located at one end of the transmission shaft 6. The second telescopic shaft 31 of the second electromagnetic valve 30 is connected with one end of the transmission shaft 6, and the second electromagnetic valve 30 drives the transmission shaft 6 to move axially through the second telescopic shaft 31. In this example, the second electromagnetic valve 30 is energized to extend out of the second telescopic shaft 31 for separation, that is, the second electromagnetic valve 30 is energized to extend out of the second telescopic shaft 31 to push the transmission shaft 6 to the side of the first motor 1, thereby compressing the spring 22 and making the connecting shaft 12 leave the output end 11. When the second electromagnetic valve 30 is powered off, due to the of the loss of electromagnetic force, the transmission shaft 6 will be pushed to the planetary gear reducer 4 side under the force of the spring 22, so that the connecting shaft 12 will be reconnected with the output end 11. The advantage of this design is that it is in an engaged state in the power-off state and has a higher security.

In some embodiments, as shown in FIGS. 14 to 17, the electric device 13 is, for example, an electric push rod 42, which is located at one end of the transmission shaft 6 and installed on a support 40. The telescopic end of the electric push rod 42 is arranged at intervals from one end of the transmission shaft 6. In this example, the second telescopic shaft 31 of the second electric telescopic unit being connected with one end of the transmission shaft 6 means that when separation is required, the electric push rod 42 works to extend out the third telescopic shaft 43 to push the transmission shaft 6 to the side of the first motor 1, thereby compressing the spring 22 and making the connecting shaft 12 leave the output end 11. When engagement is needed, the electric push rod 42 works to retract the third telescopic shaft 43 to cancel the jacking for the transmission shaft 6. Under the force of the spring 22, the transmission shaft 6 will move to the side of the planetary gear reducer 4, so that the connecting shaft 12 is reconnected with the output end 11. The telescopic end of the electric push rod 42 and one end of the transmission shaft 6 return to the state of interval distribution, so that it is not necessary to keep the electric device 13 connected with the transmission shaft 6 all the time. When the transmission shaft 6 rotates in the engaged state, it will not interact with the electric device 13.

As shown in FIGS. 14 and 15, one side of the planetary gear reducer 4 is also provided with a casing 41, and the electric push rod 42 is protected by the casing 41. In addition, the casing 41 also serves as an integral part of the appearance of the whole electric winch, thus contributing to a more beautiful appearance of the whole electric winch.

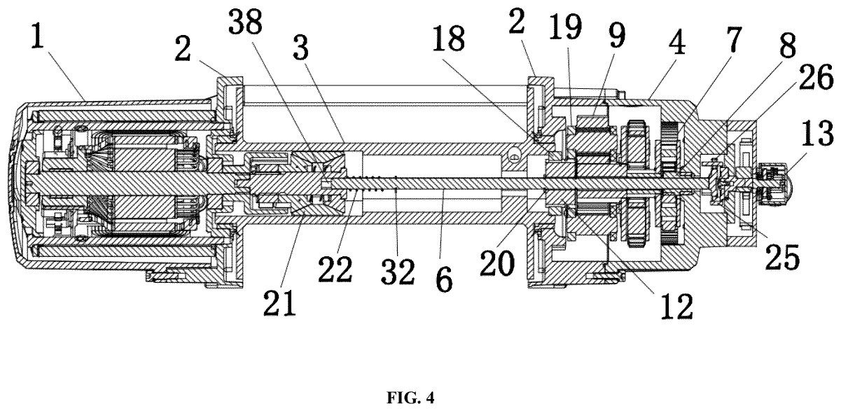

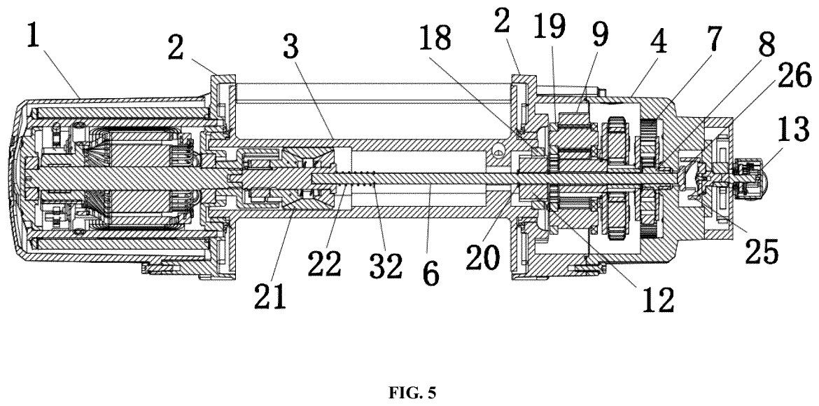

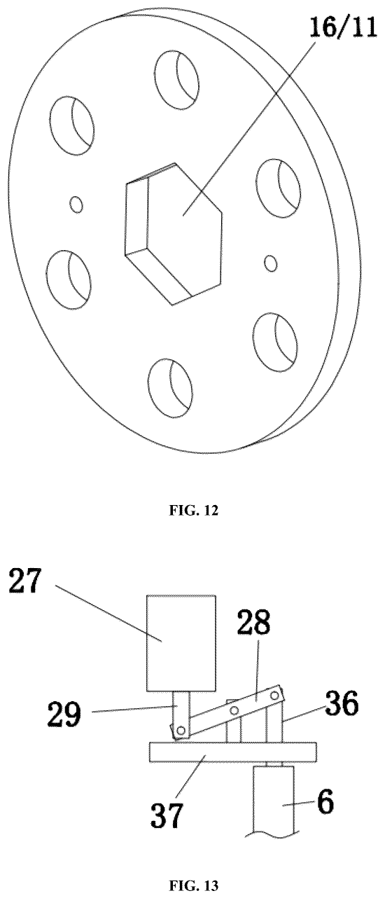

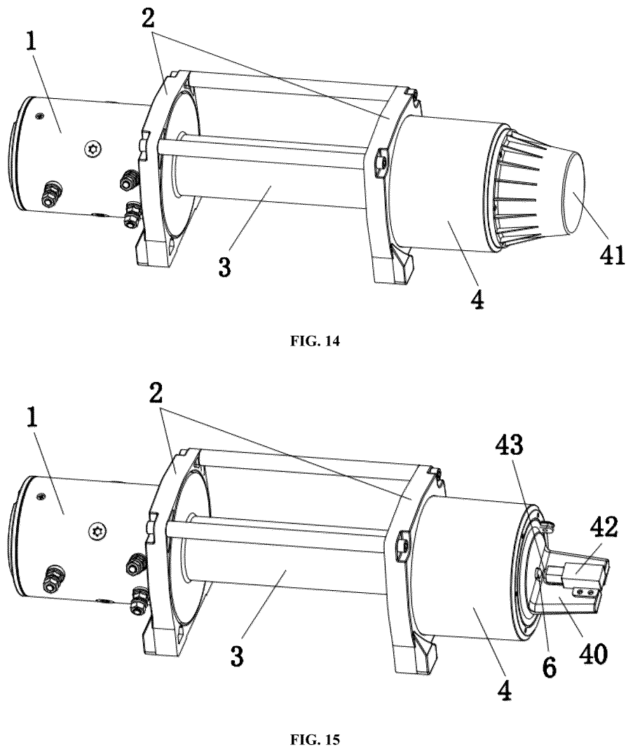

The electric device 13 can also adopt other technical solutions, such as those shown in FIGS. 4 and 5, or as shown in FIG. 13.

The main difference between FIGS. 4 and 5 compared with FIGS. 2 and 3 lies in the electric device 13. For more details, please refer to FIGS. 8 to 10. The electric device 13 shown in FIGS. 4 and 5 includes a second motor 23, a reducer 24, a rotating part 25 and a mating part 26, which are sequentially connected in transmission. The rotating part 25 is mated with the mating part 26, and the mating part 26 is arranged on the transmission shaft 6. The rotation of that rotate part 25 can drive the axial movement of the mating part 26, so that the axial movement of the mating part 26 drives the axial movement of the transmission shaft 6, thereby the axial movement of the transmission shaft 6 can be driven by converting the rotation into the axial movement, which has greater thrust and is more reliable than the second electromagnetic valve 30.

As shown in FIGS. 8 to 10, the rotating part 25 is provided with a track 39 in the axial direction. When the rotating part 25 and the mating part 26 rotate relatively, the mating part 26 can move axially along the track 39, that is, when the rotating part 25 rotates forward, the mating part 26 is guided by the track 39 to drive the transmission shaft 6 to the side of the first motor 1, thereby compressing the spring 22 and making the connecting shaft 12 leave the output end 11. When the rotating part 25 rotates reversely, the mating part 26 is guided by the track 39 and moves toward the planetary gear reducer 4. At this time, under the force of the spring 22, the transmission shaft 6 and the mating part 26 are pushed toward the planetary gear reducer 4, so that the connecting shaft 12 is reconnected with the output end 11.

The mating part 26 is guided by the track 39 and moves toward the planetary gear reducer 4, that is, the limit of the transmission shaft 6 is released, so that the spring 22 can play a role.

In addition to the above circumstance, the specific structural forms of the rotating part 25 and the mating part 26 can be other structures, such as threaded connection, electric lead screw, electric push rod, etc.

In some embodiments, in order to make the rotation safer and more reliable, as shown in FIGS. 8, 9 and 10, the rotating part 25 is also provided with a trigger part 35. A first position sensor 33 and a second position sensor 34 are arranged in the circumferential direction of the trigger part 35, and the trigger part 35 can abut against the first position sensor 33 or the second position sensor 34 when rotating, thus forming two position signals, which is beneficial to improving safety and reliability. In this example, the trigger portion 35 is provided as a circumferential protrusion.

In some embodiments, in order to make the positioning more reliable after reaching the position, a positioning structure is also provided between the rotating part 25 and the mating part 26. As shown in FIG. 8 to FIG. 10, the positioning structure is, for example, a positioning groove 5 provided on the rotating part 25, so that the mating part 26 can be positioned reliably in two positions.

As shown in FIG. 13, another electric device 13 includes a second electric telescopic unit and a lever 28. The second electric telescopic unit adopts an electric push rod, a first electromagnetic valve 27 and the like. Taking the first electromagnetic valve 27 as an example, the first electromagnetic valve 27 is located at one end of the lever 28, and the first telescopic shaft 29 of the first electromagnetic valve 27 is connected with one end of the lever 28. The transmission shaft 6 is located at and connected with the other end of the lever 28. The first electromagnetic valve 27 drives the transmission shaft 6 to move axially through the lever 28. According to this design, not only can the amplification of the lever arm be used to provide a larger force, and the force drives the transmission shaft 6 to move axially, which is beneficial to improving stability. The axial movement speed is faster and the response speed is better than that of rotation.

In some embodiments, as shown in FIG. 13, the transmission shaft 6 is connected with the other end of the lever 28 through a transition shaft 36, and the lever 28 is rotatably connected to a mounting seat 37, thus facilitating the structural arrangement and assembly. The mounting seat 37 can be an end cover of the electric winch, and the transition shaft 36 passes through the end cover and is connected with the transmission shaft 6.

In this embodiment, as shown in FIG. 18, the controller 44 includes a clutch button, and the electric device also includes a control unit which is in signal-connection with the controller 44, a driving unit and a conducting unit which are electrically connected with the control unit, and the control unit is electrically connected with the second electromagnetic valve 30.

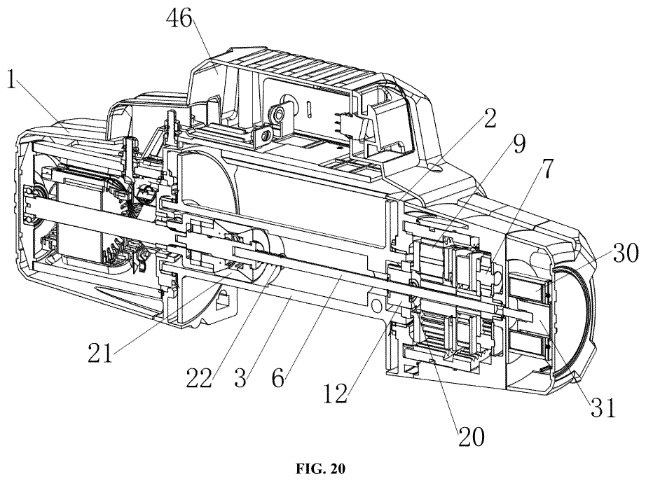

In some embodiments, as shown in FIGS. 19 and 20, a component mounting area 46 can be installed above the bracket 2, which can be used to install electronic components needed by the electric winch, such as control unit, driving unit, conducting unit, storage battery, reversing contactor, relay, etc.

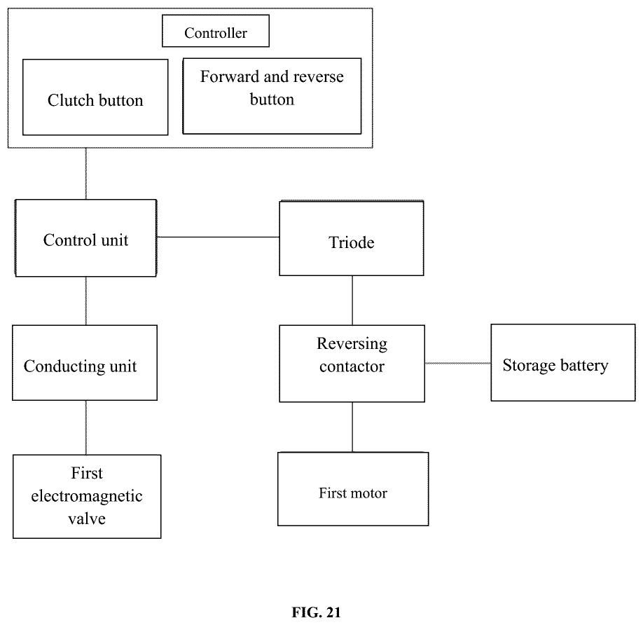

Referring to FIGS. 1, 2 and 21, the present disclosure further provides a control method for an axial electric clutch winch, which includes a first motor 1, a bracket 2, a winch drum 3, a planetary gear reducer 4 and an electric clutch structure. The electric clutch structure includes an electric device 13 and a connecting shaft 12, and the electric clutch structure is correspondingly provided with a controller 44. The controller 44 includes a clutch button. The electric device 13 includes a second electromagnetic valve 30, a second telescopic shaft 31 and a return spring 45, and further includes a control unit which is in signal connection with the controller 44, and a driving unit and a conducting unit which are electrically connected with the control unit. The method includes the following steps:
Step 1, when a user operates the clutch button of the controller 44, the clutch button making the control unit output continuous conducting signals to the driving unit; and
Step 2, the conducting unit continuously conducting and outputting a high current according to the conducting signals to electrically operate the second electromagnetic valve 30, thereby pushing the second telescopic shaft 31 to extend out to make the electric clutch structure in a separated state; and
Step 3, after the conducting signals last for a period of A, the control unit automatically changing the conducting signals into PWM signals to control the conducting unit, thereby reducing the current of the second electromagnetic valve 30 from a high current to a low current, wherein the low current is used for maintaining a push-out state of the second telescopic shaft 31; and
Step 4, if the user does not operate the controller 44 within a period of B, the control unit powering off the second electromagnetic valve 30, so that the second telescopic shaft 31 automatically retracts by the return spring 45, and thereby the electric clutch structure is in an engaged state.

The controller 44 further comprises a forward and reverse button, and if the user presses the forward and reverse button of the controller 44 within the period of B, then the control unit powers off the second electromagnetic valve 30 and retracts the second telescopic shaft 31 by controlling the conducting unit, and the control unit controls the first motor of the winch to start forward or reverse movement after a period of C; if the pressing action is canceled, the control unit controls the first motor 1 to immediately power off to stop rotating. The conducting unit adopts one or two of triode and MOS tube; the controller 44 includes a wired controller and/or a wireless controller; the controller 44 further includes a touch screen, and the clutch button and the forward and reverse buttons adopt mechanical buttons and/or touch buttons. The value range of the period A is 2 to 5 seconds, including two end time values of 2 seconds and 5 seconds; a value range of the period C is 1.5 to 3.5 seconds, including two end time values of 1.5 seconds and 3.5 seconds.

In this example, the specific control method is as follows:

When the clutch button on the controller 44 is pressed, a remote control receiver will send a signal to the control unit after receiving the signal, and the control unit will output a high level to control the conduction of the MOS tube so that the second electromagnetic valve 30 will be electrified. The second telescopic shaft 31 will extend out, and after the high level lasts for 3 seconds, it will become a PWM signal to control the MOS tube, thus reducing the current of the second electromagnetic valve 30 from 20 A to 5 A. At this time, the second electromagnetic valve 30 can still maintain enough force to maintain the state that the second telescopic shaft 31 is pushed out. Due to the decrease of current, the linear heating of the second electromagnetic valve 30 is also reduced, thus ensuring that the heating temperature of the second electromagnetic valve 30 is within 80 degrees. If the controller 44 is not operated within 10 minutes, the control unit will cut off the power of the second electromagnetic valve 30. If the forward and reverse button on the controller 44 is pressed within 10 minutes, the remote control receiver will give a corresponding signal to the control unit after receiving the forward or reverse signal. The control unit will first output a low-level control MOS tube to be turned off to power off the second electromagnetic valve 30 and retract the second telescopic shaft 31, and then control the reversing contactor to turn on the positive and negative directions of the battery in the required direction through the triode or MOS tube at one side of the reversing contactor 2 seconds later, so as to make the first motor 1 start the forward or reverse operation. When the forward and reverse button on the controller 44 is released, because there is no forward or reverse signal, the control unit will turn off the power supply of the battery to the first motor 1 through the triode or MOS tube at one side of the reversing contactor, and the first motor 1 will immediately stop rotating. The storage battery can also be replaced by commercial power, and the use of storage battery mainly meets the purpose of vehicle use.

The periods A and Care preferably selected according to the above ranges, so as to obtain better performance. For example, the period B is 10 minutes, but it can be other time, as long as it is set as required. The setting is set at the factory, and other structures can be further added to realize the setting at the user end and provide the user setting function. The control unit may adopt a single chip microcomputer.

The technical means disclosed in the scheme of the present invention are not limited to the technical means disclosed in the above embodiments, but also include the technical scheme composed of any combination of the above technical features. It should be pointed out that for those skilled in the art, several improvements and embellishments can be made without departing from the principle of the present invention, and these improvements and embellishments are also regarded as the protection scope of the present invention.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

What is claimed is:

1. An electric winch for axial electric clutch, comprising a first motor, a bracket, a winch drum and a planetary gear reducer, wherein
the first motor and the planetary gear reducer are respectively installed at two opposite ends of the bracket, and the winch drum is rotatably arranged between the first motor and the planetary gear reducer; and
the planetary gear reducer comprises an input-side planetary gear set and an output-side planetary gear set for driving the winch drum to rotate, and a transmission shaft passing through the winch drum is arranged between the first motor and the planetary gear reducer; and
the winch drum has an input end, the output-side planetary gear set has an output end, and a connecting shaft is arranged between the input end of the winch drum and the output end of the planetary gear set; and
wherein, one end of the connecting shaft is muff-coupled with the input end and is axially slidable, and the other end of the connecting shaft is muff-coupled the output end and is axially slidable; a clutch transmission connection is realized between the input end and the output end through the axially slidable connection of the connecting shaft; and
wherein, the connecting shaft is muff-coupled with the transmission shaft, the transmission shaft and the connecting shaft can rotate relatively, and the connecting shaft is driven to slide axially by the transmission shaft for clutch; and
the transmission shaft is connected with an electric device, and the electric device is used for driving the transmission shaft to move axially when clutch is needed.

2. The electric winch for axial electric clutch according to claim 1, wherein the input-side planetary gear set comprises an input sun gear, the transmission shaft passes through the winch drum to reach the input-side planetary gear set of the planetary gear reducer, and is in transmission connection with the input sun gear set of the input-side planetary gear set; the input-side planetary gear set is located on a side far from the bracket, and the output-side planetary gear set is located on a side close to the bracket.

3. The electric winch for axial electric clutch according to claim 1, wherein in a separated state, the connecting shaft is separated from the output end through axial movement, while the connecting shaft keeps muff-coupled with the input end, and the input end plays a role in radially supporting and axially guiding the connecting shaft;
alternatively, in the separated state, the connecting shaft is separated from the input end through axial movement, the connecting shaft keeps muff-coupled the output end, and the output end plays a role in radially supporting and axially guiding the connecting shaft.

4. The electric winch for axial electric clutch according to claim 3, wherein the input end is provided with a spline hole, one end of the connecting shaft is provided with a spline section, and the spline section is axially slidably muff-coupled the spline hole can be; the output end is provided with a regular polygon hole, the other end of the connecting shaft is provided with a regular polygon section, and the regular polygon section is axially slidably muff-coupled the regular polygon hole.

5. The electric winch for axial electric clutch according to claim 1, wherein a transmission ring is welded to the input end, and the transmission ring is configured as the input end and is axially and slidably connected with one end of the connecting shaft.

6. The electric winch for axial electric clutch according to claim 5, wherein the output-side planetary gear set further comprises an end plate, one side of the end plate close to the input end is provided with a muff-coupling hole, and the muff-coupling hole is set as the output end.

7. The electric winch for axial electric clutch according to claim 1, wherein retaining rings are respectively arranged on both sides of the connecting shaft, and the retaining rings are connected with the transmission shaft; when the electric device drives the transmission shaft to move axially, the transmission shaft pushes the connecting shaft to move axially through the retaining rings.

8. The electric winch for axial electric clutch according to claim 1, wherein a braking device is arranged between the first motor and the transmission shaft, one end of the braking device is connected with the first motor, and the other end of the braking device is axially slidably muff-coupled with the transmission shaft.

9. The electric winch for axial electric clutch according to claim 8, wherein a spring is arranged between the braking device and the transmission shaft; and
during engagement and loading, the electric device is released, the spring pushes the transmission shaft to one side of the planetary gear reducer, and the input end is engaged with the output end.

10. The electric winch for axial electric clutch according to claim 1, wherein the electric device comprises a second motor, a reducer, a rotating part and a mating part; the second motor, the reducer and the rotating part are connected in transmission in sequence, the rotating part is mated with the mating part, and the mating part is arranged on the transmission shaft; the rotation of the rotating part can drive the mating part to move axially, so that the mating part axially moves to drive the transmission shaft to move axially.

11. The electric winch for axial electric clutch according to claim 1, wherein the electric device comprises a first electric telescopic unit and a lever; the first electric telescopic unit is located at one end of the lever, and a first telescopic shaft of the first electric telescopic unit is connected with one end of the lever; the transmission shaft is located at the other end of the lever and connected with the other end of the lever, and the first electric telescopic unit drives the transmission shaft to move axially through the lever.

12. The electric winch for axial electric clutch according to claim 1, wherein the electric device comprises a second electric telescopic unit, which is located at one end of the transmission shaft; and
wherein, the second electric telescopic unit is provided with a second telescopic shaft, which is connected with one end of the transmission shaft, and the second electric telescopic unit drives the transmission shaft to move axially through the second telescopic shaft.

13. An electric winch for axial electric clutch, comprising a bracket, a first motor and a planetary gear reducer respectively installed at opposite ends of the bracket, and a winch drum rotatably installed between the first motor and the planetary gear reducer; and
wherein, the planetary gear reducer comprises an output-side planetary gear set for driving the winch drum to rotate, and a transmission shaft passing through the winch drum is arranged between the first motor and the planetary gear reducer;
an electric clutch structure is arranged between the output-side planetary gear set and the winch drum, and the electric clutch structure comprises an electric device and a connecting shaft; and
wherein, the connecting shaft is positioned between the winch drum and the output-side planetary gear set; and
wherein, one end of the connecting shaft is muff-coupled with the winch drum and is axially slidable, and the other end of the connecting shaft is muff-coupled the output-side planetary gear set and is axially slidable; and
wherein, the connecting shaft is muff-coupled with the transmission shaft, the transmission shaft and the connecting shaft can rotate relatively, and the connecting shaft is driven to slide axially by the transmission shaft during clutch; and
the electric clutch structure is correspondingly provided with a controller.

14. The electric winch for axial electric clutch according to claim 13, wherein the winch drum has an input end, the output-side planetary gear set has an output end, and the connecting shaft is arranged between the input end and the output end; and
wherein, one end of the connecting shaft is muff-coupled with the input end and is axially slidable, and the other end of the connecting shaft is muff-coupled the output end and is axially slidable; a clutch transmission connection is realized between the input end and the output end through the axially slidable connection of the connecting shaft.

15. The electric winch for axial electric clutch according to claim 13, wherein the electric device comprises a second electromagnetic valve, a second telescopic shaft and a return spring; the second electromagnetic valve is located at one end of the transmission shaft, the second telescopic shaft is slidably installed in the second electromagnetic valve, and the return spring is installed between the second telescopic shaft and an inner wall of the second electromagnetic valve.

16. The electric winch for axial electric clutch according to claim 15, wherein the controller comprises a clutch button; the electric device further comprises a control unit which is in signal-connection with the controller, a driving unit and a conducting unit which are electrically connected with the control unit, and the control unit is electrically connected with the second electromagnetic valve.

17. A method for controlling an axial electric clutch winch, comprising adopting an electric winch for axial electric clutch, which comprises a first motor, a bracket, a winch planetary gear reducer and an electric clutch structure, wherein the electric clutch structure comprises an electric device and a connecting shaft, the electric clutch structure is correspondingly provided with a controller, the controller comprises a clutch button, and the electric device comprises a second electromagnetic valve, a second telescopic shaft and a return spring; the electric device further comprises a control unit which is in signal connection with the controller, and a driving unit and a conducting unit which are electrically connected with the control unit; wherein the method comprises the following steps:
Step 1, when a user operates the clutch button of the controller, the clutch button making the control unit output continuous conducting signals to the driving unit; and
Step 2, the conducting unit continuously conducting and outputting a high current according to the conducting signals to electrically operate the second electromagnetic valve, thereby pushing the second telescopic shaft to extend out to make the electric clutch structure in a separated state; and
Step 3, after the conducting signals last for a period of A, the control unit automatically changing the conducting signals into PWM signals to control the conducting unit, thereby reducing the current of the second electromagnetic valve from a high current to a low current, wherein the low current is used for maintaining a push-out state of the second telescopic shaft; and
Step 4, if the user does not operate the controller within a period of B, the control unit powering off the second electromagnetic valve, so that the second telescopic shaft automatically retracts by the return spring, and thereby the electric clutch structure is in an engaged state.

18. The method for controlling an axial electric clutch winch according to claim 17, wherein the controller further comprises a forward and reverse button, and if the user presses the forward and reverse button of the controller within the period of B, then the control unit powers off the second electromagnetic valve and retracts the second telescopic shaft by controlling the conducting unit, and the control unit controls the first motor of the winch to start forward or reverse movement after a period of C; and
if the pressing action is canceled, the control unit controls the first motor to immediately power off to stop rotating.

19. The method for controlling an axial electric clutch winch according to claim 18, wherein the conducting unit adopts one or two of triode and MOS tube; the controller comprises a wired controller and/or a wireless controller; the controller further comprises a touch screen, and the clutch button and the forward and reverse buttons adopt mechanical buttons and/or touch buttons.

20. The method for controlling an axial electric clutch winch according to claim 17, wherein a value range of the period A is 2 to 5 seconds, including two end time values of 2 seconds and 5 seconds; a value range of the period C is 1.5 to 3.5 seconds, including two end time values of 1.5 seconds and 3.5 seconds.
